(19) United States
(12) Patent Application Publication
(10) Pub. No.: US 2003/0137121 A1
(43) Pub. Date: Jul. 24, 2003

(54) Offset axle

(76) Inventors: Paul Lenz, Waldkirchen (DE); Alfred Junk, Passau (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/276,570

(22) PCT Filed: Jun. 2, 2001
(86) PCT No.: PCT/EP01/06315

(30) Foreign Application Priority Data
Jun. 7, 2000 (DE) 100 28 278.4

(51) Int. Cl. B60G 3/12

(52) U.S. Cl. 280/124.128

(57) ABSTRACT

The offset axle for buses has a housing in which a differential is located, said differential being connected to two axle shafts; and a suspension for connecting the housing to the vehicle. Said suspension has single or multiple part spring carriers which consist of corelessly, completely cast metal. Humps can be provided in the area of the curvature between the spring element and the housing in order to increase strength.

### FIELD OF THE INVENTION

The present invention concerns an offset axle for motor vehicles, especially omnibuses, with a housing, in which a differential is placed, which differential is connected to two axle shafts and said offset axle has a hanger system for the connection of the housing with the vehicle, in accord with the principal concept of claim 1.

### BACKGROUND OF THE INVENTION

Offset axles for omnibuses have been long known. By means of offset axles the lowest possible omnibus passenger floor surface can be created, and said omnibus floor can be placed directly between the driven wheels. DE A 22 56 121 describes an axle arrangement for omnibuses, in which, by means of pivotable shafts, the differential of an omnibus axle are set lower than the actual wheel drive shafts. Thereby, wheel assemblies can be prefabricated with separate reduction drives.

It is considered an optimal arrangement, where municipal omnibuses are concerned, if the possibility can be realized, of placing the floor into a standard wheelbase frame equally spaced between the wheels. Further, said floor, should be arranged over the entire length of the omnibus at such a height above the pavement, that with a maximum of one step from the sidewalk the floor can be reached. A method of attaining this advantage was proposed in DE 3 027 806 of the applicant, which included a countershaft offset a distance lower than the wheel drive shafts and between the spur gear driven, counter shaft drives on each side. This system is essentially comprised of a countershaft placed in an offset axle housing, which said shaft binds together the two spur gear, auxiliary drives in immediate proximity to the wheels. The system further consists of a bevel gear drive with a differential. The power take-off bevel gear of the said differential turns fixedly with the counter shaft.

The driving bevel gear of said differential, is connected by means of a universal joint with the shifting transmission, that is to say, with the motor of the omnibus.

Finally DE 196 04 730 of the applicant, describes an offset axle for low-floor municipal omnibuses with a compensation gear drive, the axle shafts of which penetrate a pinion gear of an offset transmission with a reducing action, which is situated to be free running and self centering between two intermediate pinon gears. Each of the said axle shafts transmits respectively half of the drive load onto a spur gear for the wheel drive, whereby the axle shafts, conditioned by the two offset drives lie lower about the offset depth than do the wheel axles. In order to integrate the disk brakes into the offset axle system, without simultaneously diminishing the walkway width of the floor in the vehicle in the area of the axle and, by means of reduced offset depth, in order to achieve a low floor height, the axle shafts are placed off-center on the upper rim of the interior of the axle bridge housing.

These known offset axles have in common, that the employed spring carriers, which may be of one or more pieces, are conventionally made as cast components with an inner core and with core supports. These spring carriers, i.e., spring carrier halves, thus occupy a relatively large volume, since they possess an inner core. Additionally, the spring carrier is weakened in the critical zones, because of the necessary core supports. From the view point of foundry technology, the said core supports cannot be eliminated. Thus, because of the large construction size, these spring carriers are relatively heavy.

The purpose of the present invention is, to formulate the spring carriers, or the spring carrier halves-, for the offset axle, especially for omnibuses, in such a manner, that first, a saving in weight is achieved, and second, a cost reduction for their manufacture is made possible.

Basing consideration on an offset axle of the kind named in the introductory passages, the achievement of this purpose is carried out with the features made known in the characterized part of claim 1. Advantageous embodiments are described in the subordinate claims.

### SUMMARY OF THE INVENTION

In accord with the invention, provision is also made, that the spring carriers are made from coreless, completely cast metal. In this way, the core and the core supports, which were required in the past, are eliminated.

The critical zone for structural strength is, as a rule, the curved portion between the air spring and the offset housing. Optionally, in this area, in accord with the invention, an upper or lower increase in the depth of the structure of the carrier is made, which stabilizes said carrier in this area.

With the spring carrier formulated in accord with invention, a weight saving of approximately 20% per carrier is achieved. The cost reduction rests on the discarding of the inner core and the core supports. At the same time, an improvement of the geometrical moment of inertia is achieved.

An optimal formulation of the invented spring carrier is given, when this is installed concavely upward, that is, the bow embraces the bottom of the vehicle.

In the area between the attachment to the spur gear-auxiliary gear drive and the first load bearing face, it is of advantage, if the spring carrier is built to be as straight a line as is possible. This is obviously can only be done within those limits, which are made free by the tire clearance.

### BRIEF DESCRIPTION OF THE DRAWINGS

In the following, tThe invention will be explained in greater detail with the aid of the drawing, in which an advantageous embodiment is presented. There is shown in:

now be described, by way of example, with reference to the accompanying drawings in which:

FIG. 1 is a perspective view of a conventional spring carrier;

FIG. 2 is a perspective view of a spring carrier in accord with the invention;

FIG. 3 to FIG. 7 are variousis a perspective profile views of an invented spring carriers; and

carrier;

FIG. 4 is a top plan view of the carrier in FIG. 3;

FIG. 5 is an end view of the invented spring carrier;

FIG. 6 is a partial cut-away sectional view;

FIG. 7 is a perspective view, similar to that as seen in FIG. 2; and

FIG. 8 is a perspective view of a one piece spring carrier for an omnibus.

### DETAILED DESCRIPTION OF THE INVENTION

Offset axles for motor vehicles and especially for omnibuses, are well known to the expert. Accordingly, in the above Figures, only the essential parts necessary for understanding of the invention are presented. Normally, the offset axles consist of a housing, in which a differential is enclosed, and which is connected with two axles, further, a hanger for the connection of the housing to the vehicle is included which possesses one-piece or multi-piece spring carriers, which are affixed, first, to the housing, and second, by means of damping elements or spring elements to the vehicle.

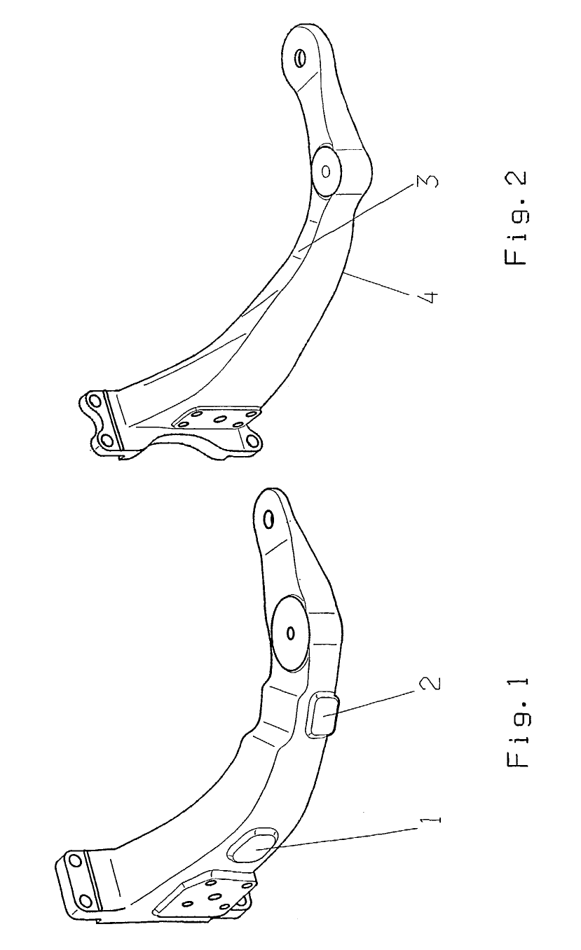

A portion of a two-piece spring carrier is shown in FIG. 1 in perspective view. In this case, this spring carrier includes, in the conventional manner, (not shown in the drawing) an inner core, along with two core supports, namely 1 and 2. Such a spring carrier is voluminous, because of the said inner core. Additionally, the carrier is weakened by means of the core supports, which are located in its critical areas. Because of foundry technological reasons, these core supports cannot be done away with. Because of its method of construction, this conventional spring carrier is relatively heavy.

FIG. 2 shows a perspective view of a coreless, fully cast spring carrier. In this case, the previously necessary inner core has been eliminated along with its core supports. Critical to the manufacture, as a rule, is the curved section 3 between the pneumatic damping means and the offset housing. Increases in vertical cross-sections can, optionally, be supplied in this said critical area on the top or bottom of the curved section. The purpose of so increasing the web is to stabilize the component in the said area. In FIG. 2, the curved increase in depth is shown at the bottom.

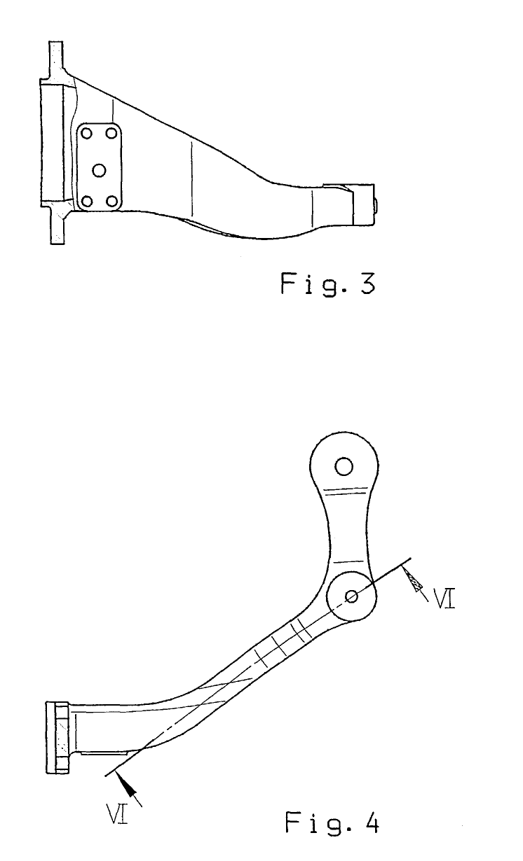

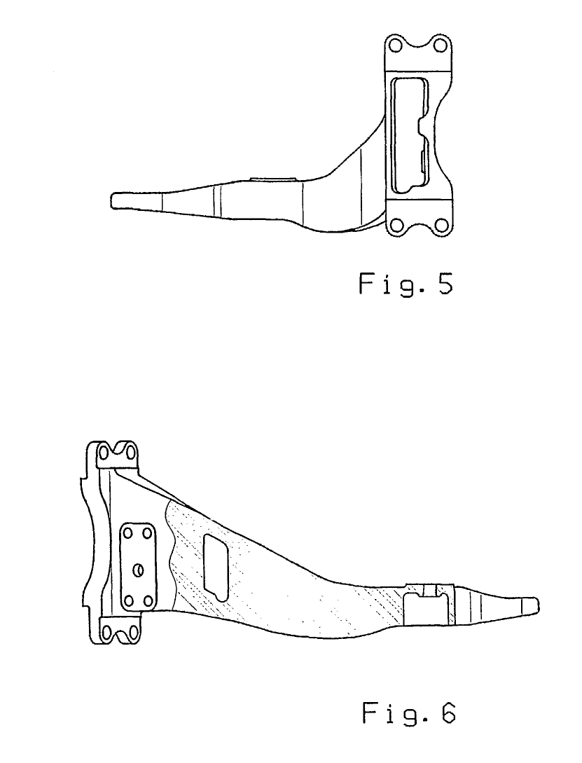

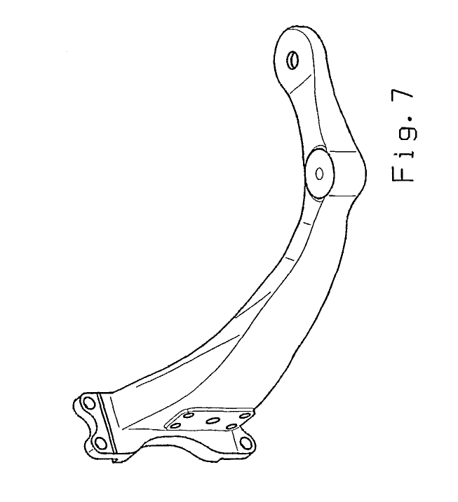

FIG. 3 shows in perspective view, a profile view of an invented spring carrier and FIG. 4 depicts the same carrier a seen in a top view. FIG. 5 shows an end view of the invented spring carrier and FIG. 6 a partial cut-away sectional view. FIG. 7

The present invention concerns an offset axle for motor vehicles, especially omnibuses, with a housing, in which a differential is placed, which differential is connected to two axle shafts and said offset axle has a hanger system for the connection of the housing with the vehicle, in accord with the principal concept of claim 1.

Offset axles for omnibuses have been long known. By means of offset axles the lowest possible omnibus passenger floor surface can be created, and said omnibus floor can be placed directly between the driven wheels. DE A 22 56 121 describes an axle arrangement for omnibuses, in which, by means of pivotable shafts, the differential of an omnibus axle are set lower than the actual wheel drive shafts. Thereby, wheel assemblies can be prefabricated with separate reduction drives.

It is considered an optimal arrangement, where municipal omnibuses are concerned, if the possibility can be realized, of placing the floor into a standard wheelbase frame equally spaced between the wheels. Further, said floor, should be arranged over the entire length of the omnibus at such a height above the pavement, that with a maximum of one step from the sidewalk the floor can be reached. A method of attaining this advantage was proposed in DE 3 027 806 of the applicant, which inoluded a countershaft offset a distance lower than the wheel drive shafts and between the spur gear driven, counter shaft drives on each side. This system is essentially comprised of a countershaft placed in an offset axle housing, which said shaft binds together the two spur gear, auxiliary drives in immediate proximity to the wheels. The system further consists of a bevel gear drive with a differential. The power take-off bevel gear of the said differential turns fixedly with the counter shaft.

The driving bevel gear of said differential, is connected by means of a universal joint with the shifting transmission, that is to say, with the motor of the omnibus.

The two spur gear counter drives, in this arrangement, are designed as double-auxiliary gear-transmissions with power branches through two interposed gears continually engaged with the output gear. In this way, one of the spur gear-auxiliary transmissions plus the beveled gear and also the differential are all placed in a common housing. Further, both housings exhibit fastening points to the vehicle framing. Further, both housings, are bound together by an axle housing of minimal mounting height in the center of the vehicle and within which a stub shaft is integrated as the longer part of the undivided countershaft.

By the above means, favorable gear ratio steps were obtained, and a better quiet run and thinner gears were made possible. At the same time, the height of the offset distance to comply with the general dimensioning required in the practice for an optimal entry step height could be achieved with a full passenger floor width.

EP B 599 293 discloses a driven axle arrangement for vehicles, with a central housing, with elements for hanging which can secure the housing to the vehicle frame having further a main input drive, which is placed in the central housing and the said arrangement also has a differential drive unit, with side takeoff drives which are located at the outer ends of the central housing. The arrangement also has wheel hub units, which respectively are attached to the said side takeoff drives, wherein an offset distance is established, to separate a middle axle, a differential drive unit, which is in the central housing, and a longitudinal axle of the wheel hub. The hanging elements, which bind the cental housing to the vehicle, are also integrally connected to the housings of the side takeoff drives. This latter feature brings the central housing and the hanging elements into a compact unit, wherein the hanging elements, which are, essentially, C-shaped arms, also, beyond the above, serve as connection points for the fastening of the axle arrangement onto the vehicle.

The hanging elements and the housing of the side drives, in the case of this known offset axle, are made as one piece, whereby, the essentially C-shaped arms are made out of a hollow structural members, which possess on the ends of the arms, which are distal from the central housing, air suspension units and shock absorber elements which include damping elements.

Finally DE 196 04 730 of the applicant, describes an offset axle for low-floor municipal omnibuses with a compensation gear drive, the axle shafts of which penetrate a pinion gear of an offset transmission with a reducing action, which is situated to be free running and self centering between two intermediate pinon gears. Each of the said axle shafts transmits respectively half of the drive load onto a spur gear for the wheel drive, whereby the axle shafts, conditioned by the two offset drives lie lower about the offset depth than do the wheel axles. In order to integrate the disk brakes into the offset axle system, without simultaneously diminishing the walkway width of the floor in the vehicle in the area of the axle and, by means of reduced offset depth, in order to achieve a low floor height, the axle shafts are placed off-center on the upper rim of the interior of the axle bridge housing.

These known offset axles have in common, that the employed spring carriers, which may be of one or more pieces, are conventionally made as cast components with an inner core and with core supports. These spring carriers, i.e., spring carrier halves, thus occupy a relatively large volume, since they possess an inner core. Additionally, the spring carrier is weakened in the critical zones, because of the necessary core supports. From the view point of foundry technology, the said core supports cannot be eliminated. Thus, because of the large construction size, these spring carriers are relatively heavy.

The purpose of the present invention is, to formulate the spring carriers, or the spring carrier halves, for the offset axle, especially for omnibuses, in such a manner, that first, a saving in weight is achieved, and second, a cost reduction for their manufacture is made possible.

Basing consideration on an offset axle of the kind named in the introductory passages, the achievement of this purpose is carried out with the features made known in the characterized part of claim 1. Advantageous embodiments are described in the subordinate claims.

In accord with the invention, provision is also made, that the spring carriers are made from coreless, completely cast metal. In this way, the core and the core supports, which were required in the past, are eliminated.

The critical zone for structural strength is, as a rule, the curved portion between the air spring and the offset housing. Optionally, in this area, in accord with the invention, an upper or lower increase in the depth of the structure of the carrier is made, which stabilizes said carrier in this area.

With the spring carrier formulated in accord with invention, a weight saving of approximately 20% per carrier is achieved. The cost reduction rests on the discarding of the inner core and the core supports. At the same time, an improvement of the geometrical moment of inertia is achieved.

An optimal formulation of the invented spring carrier is given, when this is installed concavely upward, that is, the bow embraces the bottom of the vehicle.

In the area between the attachment to the spur gear-auxiliary gear drive and the first load bearing face, it is of advantage, if the spring carrier is built to be as straight a line as is possible. This is obviously can only be done within those limits, which are made free by the tire clearance.

In the following, the invention will be explained in greater detail with the aid of the drawing, in which an advantageous embodiment is presented. There is shown in:

FIG. 1 is a perspective view of a conventional spring carrier;

FIG. 2 is a perspective view of a spring carrier in accord with the invention;

FIG. 3 to FIG. 7 are various perspective views of invented spring carriers; and

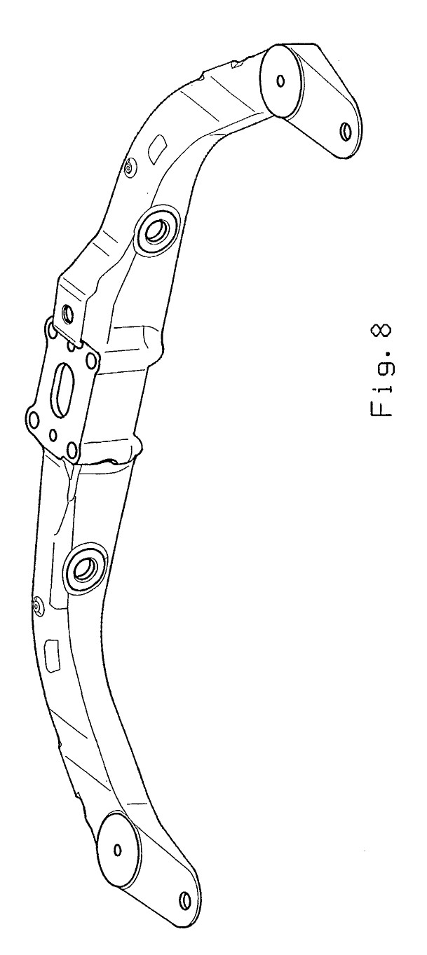

FIG. 8 is a perspective view of a one piece spring carrier for an omnibus.

Offset axles for motor vehicles and especially for omnibuses, are well known to the expert. Accordingly, in the above Figures, only the essential parts necessary for understanding of the invention are presented. Normally, the offset axles consist of a housing, in which a differential is enclosed, and which is connected with two axles, further, a hanger for the connection of the housing to the vehicle is included which possesses one-piece or multi-piece spring carriers, which are affixed, first, to the housing, and second, by means of damping elements or spring elements to the vehicle.

A portion of a two-piece spring carrier is shown in FIG. 1 in perspective view. In this case, this spring carrier includes, in the conventional manner, (not shown in the drawing) an inner core, along with two core supports, namely 1 and 2. Such a spring carrier is voluminous, because of the said inner core. Additionally, the carrier is weakened by means of the core supports, which are located in its critical areas. Because of foundry technological reasons, these core supports cannot be done away with. Because of its method of construction, this conventional spring carrier is relatively heavy.

FIG. 2 shows a perspective view of a coreless, fully cast spring carrier. In this case, the previously necessary inner core has been eliminated along with its core supports. Critical to the manufacture, as a rule, is the curved section 3 between the pneumatic damping means and the offset housing. Increases in vertical cross-sections can, optionally, be supplied in this said critical area on the top or bottom of the curved section. The purpose of so increasing the web is to stabilize the component in the said area. In FIG. 2, the curved increase in depth is shown at the bottom.

FIG. 3 shows in perspective view, a profile view of an invented spring carrier and FIG. 4 depicts the same carrier a seen in a top view. FIG. 5 shows an end view of the invented spring carrier and FIG. 6 a partial cut-away sectional view. FIG. 7 provides a presentation, similar to that as seen in FIG. 2. FIG. 8 demonstrates a one-piece spring carrier in accord with the invention, that is, a coreless, fully cast component without an inner core and without core supports. This embodiment as shown in FIG. 8, is especially suitable for application in travel omnibuses.

As already mentioned, a coreless, fully cast spring carrier, for offset axles on omnibuses, provides a weight reduction of some 20% per carrier. Because of the elimination of the inner core and core supports, a less expensive manufacturing cost is achieved. At the same time, the advantage of an improved geometrical moment of inertia is attained.

Reference Numerals

1 core support

2 core support

3 a critical curved section

4 vertical depth of carrier, dimensioned by structural calculation

Claimed is:

1. An offset axle for motor vehicles, especially for omnibuses, with a housing, in which
is placed a differential to which two axles are connected and has a hanging means for connection of housing to the vehicle, which hanging means comprises one-piece or multi-piece spring carriers, which first, are affixed to the housing and second are affixed to the vehicle by means of a spring or damping elements, therein characterized, in that the spring carriers are made of coreless, fully cast metal.

2. An offset axle in accord with claim 1, therein characterized, in that in the extent of the curved section (3) between the spring element and the housing, vertical increases in member depth (4) have been provided to increase the structural strength.

3. An offset axle in accord with the claims 1 and 2, therein characterized, in that the spring carrier is curved in the direction toward the underside of the vehicle.

4. An offset axle in accord with one of the foregoing claims, therein characterized, in that the spring carrier, in the area between its connection onto the housing and its first load bearing surface, is nearly constructed in a straight line, which is advantageous for a spring element.
